(19) United States
(12) Patent Application Publication
(10) Pub. No.: US 2006/0248093 A1
(43) Pub. Date: Nov. 2, 2006

(54) Method for determining relationships between data resources

(76) Inventors: Ora Lassila, Hollis, NH (US); Sadhna Ahuja, Waltham, MA (US)

Correspondence Address: PERMAN & GREEN, 425 POST ROAD, FAIRFIELD, CT, 06824, US

(21) Appl. No.: 11/118,602

(22) Filed: Apr. 29, 2005

(51) Int. Cl. G06F 7/00; G06F 17/00

(52) U.S. Cl. 707/100

(57) ABSTRACT

The present invention relates to an entailment method comprising: defining a virtually reified statement on the basis of information already described in a data structure describing relationships between resources, and applying the virtually reified statement, besides information in the data structure, for further processing of the data structure.

### FIELD OF THE INVENTION

The present invention relates to determining relationships between data resources, and more specifically to entailing in a Resource Description Framework (RDF) system.

### BACKGROUND OF THE INVENTION

The Semantic Web may be considered as an extension of the current Web in which information is given a well-defined meaning. On the Semantic Web, content and services will be associated with declarative semantics; descriptions of semantics are based on a foundational representational formalism called the Resource Description Framework (RDF), standardized by the World Wide Web Consortium (W3C), www.w3c.org. RDF specifies a simple model for knowledge representation in terms of objects, properties and values. RDF data can be represented as a graph containing nodes that represent various Web resources and arcs that represent the properties of the resources or relationships between the resources. Nodes and arcs in RDF are named using URIs (Uniform Resource Identifiers). A combination of two arc endpoints and the arc connecting them, in RDF parlance, is called a “statement”, and it asserts some fact about the resource involved (statements are also called “triples”).

Inference is one of the basic principles of the Semantic Web. Basically, inference means that new data is derived, by utilizing certain rules, from data already known. RDF Schema is a datatyping model for RDF and adds semantics to the basic RDF model. Entailment, as defined by the RDF Semantics document “RDF Semantics”, W3C Recommendation, 10 Feb. 2004, http://www.w3.org/TR/rdf-mt/, is a basic requirement for processing RDF, and represents the kind of “semantic interoperability” that RDF-based systems have been anticipated to have in order to realize the vision of the Semantic Web. The entailment rules defined in the RDF Semantics document are applied recursively on a set of RDF statements to compute the deductive closure of the set. Deductive closure is a resulting RDF graph after a set of entailment rules or inference rules have been applied to an original RDF graph. Thus, the deductive closure represents the new statements (by the newly added triples) derived from the original information on the basis of the entailment rules. Computation of these deductive closures, however, can prove to be computationally intensive if the RDF graph has a large numbers of classes and relationships between them.

Most RDF implementations use forward-chaining closure computation, which includes inserting a set of triples defining the classes and properties in the basic RDF vocabulary, followed by recursively applying the entailment rules to entail all possible triples from the graph being asserted. However, this procedure is highly redundant, and computing the deductive closure in this fashion can be heavy both in terms of computation time as well as memory.

Another approach to closure computation is called backward-chaining, where the entailments are computed on-demand at the time of querying the data model. This approach trades off the additional time spent in answering a query with the memory requirements of storing a fully-entailed graph. One implementation of this on-demand generation of deductive closure is described in publication “Taking the RDF Model Theory Out for a Spin” by Ora Lassila, published in Ian Horrocks & James Hendler (eds.): “The Semantic Web—ISWC 2002”, Lecture Notes in Computer Science 2342, pp. 307-317, Springer Verlag, 2002. The solution presented in this document, however, still computes deductive closure for domain/range rules by inserting additional triples for every triple inserted.

### BRIEF DESCRIPTION OF THE INVENTION

There is now provided an enhanced solution for determining relationships between data resources. This solution may be achieved by a method, a data processing device and a computer program product which are characterized by what is disclosed in the independent claims. Some embodiments of the invention are set forth in the dependent claims.

The invention is based on defining a virtually reified statement on the basis of information (a first statement) already described in a data structure describing relationships between resources. The virtually reified statement is applied, besides information in the data structure, for further processing of the data structure. The definition of the “virtually reified statement” in the present context means that the statement is not actually added to the data structure, but knowledge of new relationships, such as further triples, due to the reification is obtained. At least some of these (virtual) relationships of the virtually reified statement are utilized in addition to information (other statements) existing in the graph for further processing of the metadata, whereby one or more entailment rules may be applied. The virtually reified statement thus provides information of additional paths though an RDF graph. The term “statement” is to be understood broadly to refer to any kind of expression of a relationship between resources in a data structure, for instance, expressed by an RDF triple.

In one embodiment of the invention the virtually reified statement is determined on-demand as a response to need to define further relationships associated with the first statement.

In another embodiment of the invention, a second statement is defined on the basis of application of one or more entailment rules to the virtually reified statement.

Yet in one embodiment the virtually reified statement is used for RDF range entailment and/or domain entailment.

The advantage of the present invention is that less memory is required since additional statements or triples do not need to be stored into the data structure, for instance the RDF graph, thereby resulting in savings in graph size. This is especially useful for computing deductive closures for RDFS domain and range rules. A further advantage is the reduction in computation required and time spent in inserting new triples.

### BRIEF DESCRIPTION OF THE DRAWINGS

In the following, the invention will be described in further detail by means of some embodiments and with reference to the accompanying drawings, in which

FIG. 1 is a block diagram showing a presentation of a reified statement;

FIG. 2 is a flow chart illustrating a method according to an embodiment of the present invention;

FIGS. 3a and 3b are flow charts illustrating some further embodiments of the present invention;

FIG. 4 is an example of using a reified statement for domain properties;

FIG. 5 is an example of using a reified statement for range properties; and

FIG. 6 is a block diagram illustrating a data processing device.

### DETAILED DESCRIPTION OF THE INVENTION

The invention is described in the following with reference to the RDF system and the terminology defined for the RDF. For more details on the RDF semantics, reference is made to the RDF Semantics document “RDF Semantics”, W3C Recommendation, 10 Feb. 2004, http://www.w3.org/TR/rdf-mt/, incorporated herein as a reference. RDF's vocabulary description language, RDF Schema, is a semantic extension (as defined in [RDF-SEMANTICS]) of RDF. It provides mechanisms for describing groups of related resources and the relationships between these resources. For more details on the RDF Schema, reference is made to the W3C document “RDF Vocabulary Description Language 1.0: RDF Schema” W3C Recommendation 10 Feb. 2004, http://www.w3.org/TR/rdf-schema/#ch_reificationvocab, incorporated herein as a reference.

As already mentioned, the data structure of the RDF system is a graph consisting of nodes and labeled, directed arcs. Every arc (with associated endpoints) is referred to as a statement, which essentially asserts a relationship between the endpoints. According to the RDF semantics, there are a number of cases or rules that dictate that under certain conditions, we can derive additional arcs, that is, new statements. Resources may be divided into groups called classes. The members of a class are known as instances of the class. Classes are themselves resources and may be described using RDF properties. The rdf:type property may be used to state that a resource is an instance of a class.

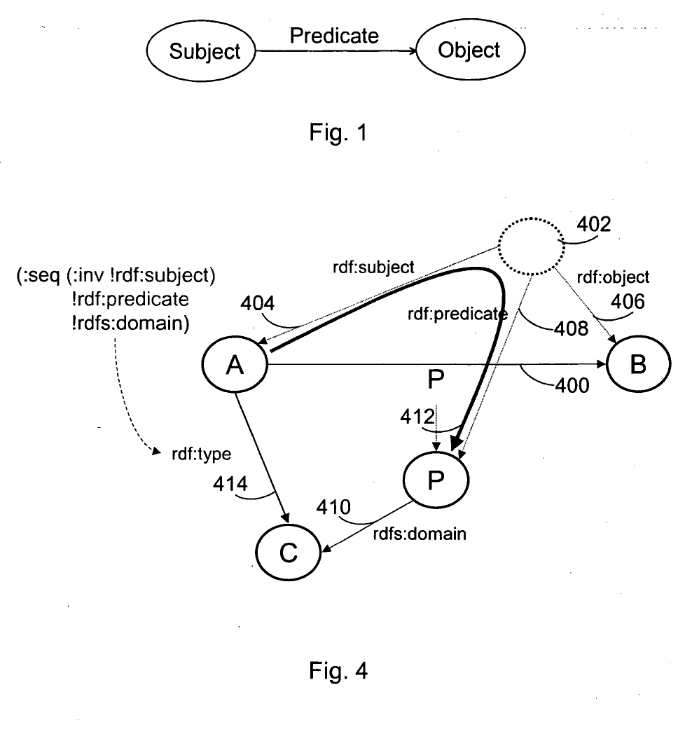

RDF provides a built-in vocabulary for describing RDF statements. A description of a statement using this vocabulary is called a reification of the statement. The RDF reification vocabulary consists of the type rdf:Statement, and the properties rdf:subject, rdf:predicate, and rdf:object. Thus, the reified statements use arc labels “subject”, “predicate” and “object”, as illustrated in FIG. 1, and may be also represented as tuples <s, p, o>. For instance, if we have a statement A--P-->B, the following reified statement S can be determined:

S--type-->Statement
S--subject-->A
S--predicate-->P
S--object-->B.

According to the present solution, for certain statements, these arcs are not added into the actual graph, but merely their existence is determined by querying the graph. This procedure is herein referred to as definition of a virtually reified statement. More specifically, this solution is applied for reified statements.

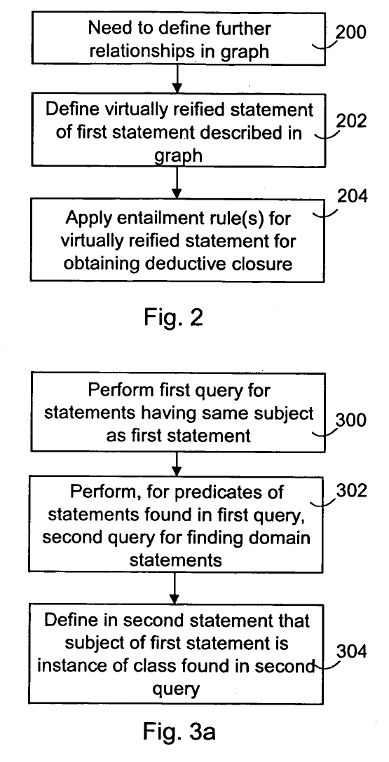

FIG. 2 illustrates a method according to an embodiment of the present invention. In step 200 there is a need to define further relationships associated with a first relationship (for instance the triple <A, P, B> already described in an RDF graph being processed. Thus, the present method may be carried out on-demand, and definition of further relationships is required only when necessary. In step 202 a virtually reified statement of a first statement already described in the RDF graph is defined. In this step virtual reification is performed for the first statement, as a result of which a virtually reified statement or a virtual reification statement is obtained. In step 204 one or more entailment rules are applied for the virtually reified statement for obtaining the deductive closure. In practise one or more further statements are defined on the basis of application of one or more entailment rules to the virtually reified statement. Thus, new paths between nodes in an RDF graph may be generated on the basis of using the virtually reified information not actually described in the graph. Information related to the virtually reified statement may be temporarily stored in a memory of a data processing the graph, but it is not necessary to store this information after the processing ends. It is to be noted that it is not necessary that the entire deductive closure is formed but only parts of the closure that are needed are defined.

Thus, the virtually reified statement is applied, besides information in the data structure, for further processing of the data structure, without requiring addition of all new relationships to the graph. The virtual reified statement does not exist (in the graph) in reality, neither do these arcs, but any pairwise sequence of any one of these arcs and the inverse of any other one of these can be queried for. The term “inverse arc” refers to traversing the arc in the opposite direction. For instance, there can be a sequence of “inverse predicate” and “subject”, and even though the arcs themselves are not part of the graph, queries can be carried out to find out further paths and relationships. Basically, for every derived arc, an alternate “path” through the “actual” graph (that is, through the data structure we already have) needs to be defined. For instance, when it is defined that “every instance of class C is also an instance of every superclass of C”, it is meant that derived arcs labeled “type” (denoting that an object is an instance of a class) have their concrete alternate paths that are essentially sequences of “type” (once) and “subClassOf” (any number of times, including zero).

The RDF vocabulary description language class and property system is similar to the type systems of object-oriented programming languages such as Java. RDF differs from many such systems in that instead of defining a class in terms of the properties its instances may have, the RDF vocabulary description language describes properties in terms of the classes of resource to which they apply. This is the role of the domain and range mechanisms. Basically, a domain of a property (the property being a description of the label naming an arc) is the class of objects that can be the starting point of the arc (i.e. the subject of a statement). Correspondingly, the range of a property is the class of objects that can be the endpoints of an arc (objects of statements). For more information on the domain and range properties, reference is made to the above mentioned document “RDF Vocabulary Description Language 1.0: RDF Schema” W3C Recommendation 10 Feb. 2004, Chapter 3.

In one embodiment, the implementation of virtual reification is illustrated for domain and range entailment. In the following path traversing implementing the domain and range rules, without actually building the graph, is illustrated. The following paths of interest will be considered:

seq(inv(rdf:subject), rdf:predicate)
seq(inv(rdf:object), rdf:predicate)

These paths are expressed using the abstract syntax of query patterns of the Wilbur Query Language (Lassila, O.: Wilbur Query Language Comparison. Nokia Research Center technical report, available online at http://wilbur-rdf.sourceforge.net2004/05/11-comparison.shtml (2004). Since any path in Wilbur Query Language has to be invertible, also the following two paths need to be considered:

seq(inv(rdf:predicate), rdf:subject)
seq(inv(rdf:predicate), rdf:object)

These paths are referred to as two-step patterns (TSPs). Associated with reified statements, TSPs are useful since they could be traversed even if the reified statements themselves did not exist, as long as it is known that they could exist and there is some other representation that provided information about them. In a “triple-store” implementation, each reified statement is represented as a tuple <s, p, o>, as already illustrated. Even without reifying at the graph level, these tuples are an alternate concrete representation of (reified) statements. Therefore, tuples are used to implement the TSPs for virtual reification. Using the vocabulary and framework introduced in connection with the Wilbur query language, we have, for example

expand (n, seq(inv(rdf:subject), rdf:predicate)) =
{p | <s, p, o> ε triple(n, *,*)}

Similarly, the other relevant TSPs can be implemented as follows:

expand (n, seq(inv(rdf:object), rdf:predicate)) =
{p | <s, p, o> ε triple(*, *,n)}
expand (n, seq(inv(rdf:predicate), rdf:subject)) =
{p | <s, p, o> ε triple(*, n,*)}
expand (n, seq(inv(rdf: predicate), rdf:object)) =
{p | <s, p, o> ε triple(*, n,*)}

With an implementation of TSPs the domain and range rules can be expressed without the need to add any new triples to the graph. The following rewrite pattern may be utilized:

rdf:type → or(seq(rdf:type, rep(rdfs:subClassOf)),

seq(inv(rdf:object), rdf:predicate, s, rdfs:range),
seq(inv(rdf:subject), rdf:predicate, s, rdfs:domain),
val(rdfs:Resource))

where s≡rep(or(p₁, . . . , pₘ)) and where p₁, . . . , p₁ are the relation rdfs:subPropertyOf and all of its subproperties.

Certain two-step sequences may be replaced with special atoms in path queries:

(:seq (:inv !rdf:object) !rdf:predicate) → :isObjectOfProperty
(:seq (:inv !rdf:subject) !rdf:predicate) → :isSubjectOfProperty

The path query expressions may be rewritten as follows.

rdf:type → or(seq(rdf:type, rep(rdfs:subClassOf)),

seq(:isObjectOfProperty, rdfs:range),
seq(:isSubjectOfProperty, rdfs:domain),
val(rdfs:Resource))

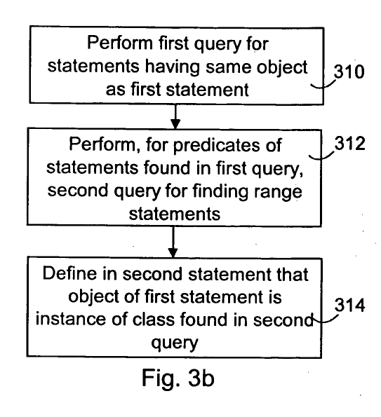

FIG. 3a illustrates an embodiment of the present invention for domain entailment. The procedures may be applied in step 204 of FIG. 2 for obtaining further relationships or statements using the virtually reified statement. In step 300 a first (triple) query is performed for finding out statements having the same subject as the first statement. It is to be noted that in addition to statements described in the graph, the virtually reified statements, are used (after calculation) in the query. In step 302 a second (triple) query is performed for finding domain statements for predicates of the statements found in the first query. On the basis of the second query, new statements may be entailed. In the present embodiment, a new statement, i.e. the second statement, defines that the subject (node) of the first statement is an instance of one or more classes found in the second query.

FIG. 4 is an example of using a virtual reified statement for domain properties. P is the predicative in the relationship 400 between A and B, i.e. the statement <A P B>. A virtual reified statement of P is represented in FIG. 4 by node 402 having the relationships 404 to 408. However, this node 402 needs not to be added to the graph. The graph includes a domain relationship 410 from P to C, i.e. the domain of P is class C. By applying the domain entailment for the virtual reified statement 402 in the manner illustrated above, the result of the first query <* * A> is P. This predicate represents the path (:seq(inv !rdf:subject)!rdf:predicate) from the node A. By applying the second query <P rdfs:domain *>, it can be entailed that A is an instance of class C, 414, i.e. A has a type relationship to C. In practice, a query engine identifies TSPs while normalizing query expressions, and substitutes a special “query atom” for each of them; special cases of the function expand then exist for each of these query atoms.

FIG. 3b illustrates an embodiment of the present invention for range entailment. The procedures Of FIG. 3b may be applied in step 204 of FIG. 2 for obtaining further relationships or statements on the basis of the virtually reified statement. A first query for finding statements having the same object as the first statement is performed in step 310. In step 312 a second query is performed for finding range statements for predicates of the statements found in the first query. On the basis of the results of the second query, it can be entailed that the object of the first statement is an instance of one or more classes found in the second query.

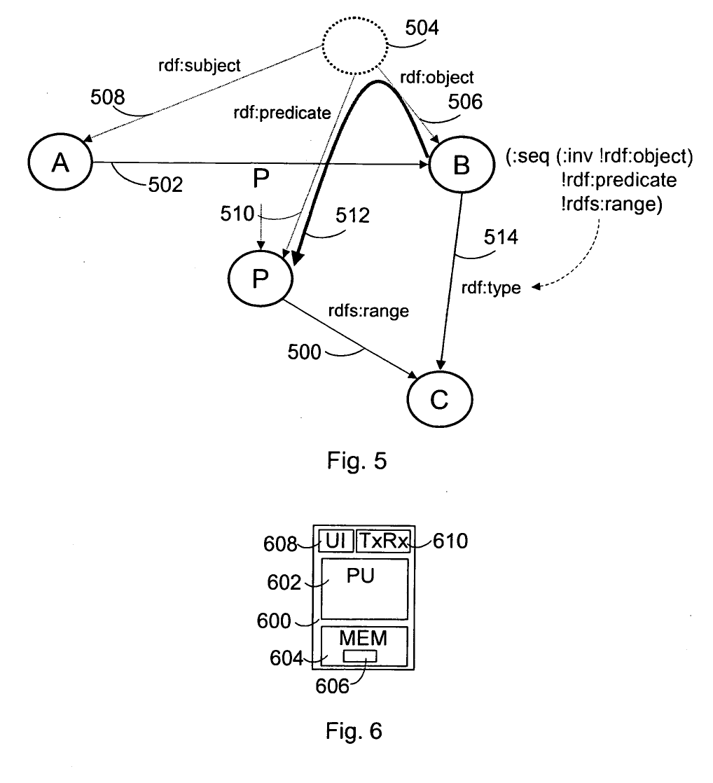

Referring to the example in FIG. 5 of using a virtual reified statement for range properties, there is a relationship 500 P--range-->C, i.e. the range of P is class C. P is the predicative in the relationship 502 between A and B. A virtual reified statement of P is represented in FIG. 5 by node 504 having the relationships 506 to 510. By applying the range entailment for the virtual reified statement 504 in the manner illustrated above, the result of the first query <* * B> is P. This predicate P represents the path (:seq(inv !rdf:object)!rdf:predicate) from the node B, as illustrated by the arrow 512. By applying the second query <P rdfs:range *>, it can be entailed 514 that B is an instance of class C, i.e. B has a type relationship to C.

The above illustrated features may be applied for automated processing of Web resources. For instance, such processing may be for resource discovery or cataloging for describing the content and content relationships available at a Web site.

As illustrated in FIG. 6, a data processing device 600 suitable for processing metadata of Web information comprises one or more processing units 602. Computer program code portions 606 stored in the memory 604 of the data processing device 600 and executed in the processing unit 602 may be used for causing the device 600 to implement means for providing the inventive functions relating to defining and utilizing virtually reified statements, some embodiments of the inventive functions were illustrated above in association with FIGS. 2, 3a, 3b, 4, and 5. For instance, this code may be a part of RDF compliant Web browser/server/search engine software providing the means to process Web metadata. The device 600 further comprises a user interface 608 and a transceiver 610 for data transfer. The data processing device 600 is not limited to any specific device, but the present features may be provided to any device suitable for retrieving and processing Web metadata. For instance, the data processing device 600 could be a conventional PC, a laptop computer, a mobile communications device, a domestic appliance device, or an auxiliary device for another electronic device. Examples of mobile communications devices are devices capable of data transmission with a PLMN network, such as a GSM/GPRS network or a third-generation network (e.g. 3GPP system).

A chip unit or some other kind of hardware module for controlling the device 600 may, in one embodiment, cause the device to perform the inventive functions. The hardware module comprises connecting means for connecting the device 600 mechanically and/or functionally. Thus, hardware module may form part of the device and could be removable. Some examples of such hardware module are a sub-assembly, a portable data storage medium, an IC card, or an accessory device. Computer program codes can be received via a network and/or be stored in memory means, for instance on a disk, a CD-ROM disk or other external memory means, where from they can be loaded into the memory of the device 600. The computer program can also be loaded through a network by using a TCP/IP protocol stack, for instance. Hardware solutions or a combination of hardware and software solutions may also be used to implement the inventive functions.

The accompanying drawings and the description pertaining to them are only intended to illustrate the present invention. Different variations and modifications to the invention will be apparent to those skilled in the art, without departing from the scope of the invention defined in the appended claims. Different features may thus be omitted, modified or replaced by equivalents.

1. A method for entailment in an RDF (Resource Description Framework) system, wherein a first statement is described in a data structure describing relationships between resources, the method comprising:
defining a virtually reified statement of the first statement by querying the data structure, and
applying the virtually reified statement, besides information in the data structure, for further processing of the data structure.

2. The method according to claim 1, wherein the virtually reified statement is defined on-demand as a response to need to define further relationships associated with the first statement.

3. The method according to claim 1, wherein a second statement is defined on the basis of application of one or more entailment rules to the virtually reified statement, besides the information in the data structure.

4. The method according to claim 3, the method being applied for domain entailment, wherein a first query for statements having the same subject as the first statement is performed,
a second query for finding domain statements is performed for predicates of the statements found in the first query, and
the second statement defines that the subject of the first statement is an instance of one or more classes found in the second query.

5. The method according to claim 3, the method being applied for range entailment, wherein a first query for statements having the same object as the first statement is performed,
a second query for finding range statements is performed for predicates of the statements found in the first query, and
the second statement defines that the object of the first statement is an instance of one or more classes found in the second query.

6. A data processing device comprising means for processing RDF (Resource Description Framework) data, the data processing device comprising:
means for defining, by querying the data structure, a virtually reified statement of a first statement in a data structure describing relationships between resources, and
means for applying the virtually reified statement, besides information in the data structure, for further processing of the data structure.

7. The data processing device according to claim 6, wherein the data processing device is configured to define the virtually reified statement on-demand as a response to need to define further relationships associated with the first statement.

8. The data processing device according to claim 6, wherein the data processing device is configured to define a second statement on the basis of application of one or more entailment rules to the virtually reified statement, besides the information in the data structure.

9. The data processing device according to claim 8, wherein the data processing device is configured to use the virtually reified statement for domain entailment, whereby the data processing device is configured to perform a first query for statements having the same subject as the first statement,
the data processing device is configured to perform a second query for finding domain statements for predicates of the statements found in the first query, and the second statement defines that the subject of the first statement is an instance of one or more classes found in the second query.

10. The data processing device according to claim 8, wherein the data processing device is configured to use the virtually reified statement for range entailment, whereby the data processing device is configured to perform a first query for statements having the same object as the first statement,
the data processing device is configured to perform a second query for finding range statements for predicates of the statements found in the first query, and the second statement defines that the object of the first statement is an instance of one or more classes found in the second query.

11. A computer program product operable on a processor, the computer program product comprising a computer program code configuring a processor to:
Define, by querying a data structure, a virtually reified statement of a first statement described in the data structure describing relationships between resources, and
apply the virtually reified statement, besides information in the data structure, for further processing of the data structure.

12. The computer program product according to claim 11, wherein the computer program product comprises a computer program code configuring a processor to define a second statement on the basis of application of one or more entailment rules to the virtually reified statement, besides the information in the data structure.

13. The computer program product according to claim 12, wherein the computer program product comprises a computer program code configuring a processor to:
perform a first query for statements having the same subject as the first statement,
perform a second query for finding domain statements is performed for predicates of the statements found in the first query, whereby the second statement defines that the subject of the first statement is an instance of one or more classes found in the second query.

14. The computer program product according to claim 12, wherein the computer program product comprises a computer program code configuring a processor to:
perform a first query for statements having the same object as the first statement,
perform a second query for finding range statements is performed for predicates of the statements found in the first query, whereby the second statement defines that the object of the first statement is an instance of one or more classes found in the second query.
